(19) United States
(12) Patent Application Publication
(10) Pub. No.: US 2024/0086935 A1
(43) Pub. Date: Mar. 14, 2024

(54) INFORMATION PROCESSING SYSTEM AND INFORMATION PROCESSING METHOD

(71) Applicant: TOYOTA JIDOSHA KABUSHIKI KAISHA, Toyota-shi (JP)

(72) Inventors: Masashi MATSUMOTO, Nagoya-shi (JP); Masayuki NAKA, Okazaki-shi (JP); Yasunobu SEKI, Nisshin-shi (JP); Hiroki AWANO, Susono-shi (JP); Tsuyoshi KANEKO, Nisshin-shi (JP); Kosuke YONEKAWA, Nisshin-shi (JP)

(73) Assignee: TOYOTA JIDOSHA KABUSHIKI KAISHA, Toyota-shi (JP)

(21) Appl. No.: 18/212,755

(22) Filed: Jun. 22, 2023

(30) Foreign Application Priority Data
Sep. 13, 2022 (JP) 2022-145190

(51) Int. Cl. G06Q 30/018

(52) U.S. Cl. CPC G06Q 30/018

(57) ABSTRACT

The information processing system includes: a data acquisition unit that acquires component data of a reusable product related to environmental contribution of the reusable product including at least the number of times of reuse of the reusable product; a selection unit that selects a candidate of the reusable product that is a replacement component candidate when the user replaces the component; a calculation unit that calculates an environmental contribution degree of the candidate of the reusable product selected by the selection unit based on the component data of the reusable product acquired by the data acquisition unit; and a presentation unit that presents, to the user, the environmental contribution degree of the candidate of the reusable product calculated by the calculation unit together with the candidate of the reusable product selected by the selection unit.

### CROSS-REFERENCE TO RELATED APPLICATION

This application claims priority to Japanese Patent Application No. 2022-145190 filed on Sep. 13, 2022, incorporated herein by reference in its entirety.

### BACKGROUND

### 1. Technical Field

The present disclosure relates to an information processing system and an information processing method related to a reusable item.

### 2. Description of Related Art

In recent years, carbon neutral has attracted attention, and effective utilization of limited resources has been demanded. For example, when a product is finely decomposed to a material level, such as material recycling, a large amount of energy is required, and therefore, it may be desirable to effectively utilize reusable items. In particular, there is a demand for so-called cascade reuse in which one reusable item is reused many times for a long period of time by changing the usage.

In view of this, for example, a system is known in which information acquired from a reusable battery is transmitted to a desired terminal of a user (see Japanese Unexamined Patent Application Publication No. 2021-158565 (JP 2021-158565 A)).

### SUMMARY

In the above system, for example, the user can select a reusable battery based on the transmitted information, change the usage, or the like, and reuse the battery. However, on the other hand, since the battery is also easily deteriorated, the user tends to preferentially select a battery that is not used much, and thus it is not possible to promote cascade reuse.

The present disclosure has been made to solve such issues, and an object of the present disclosure is to provide an information processing system and an information processing method capable of promoting cascade use by a user and improving environmental awareness of the user.

An information processing system according to a first aspect of the present disclosure includes: a data acquisition unit that acquires part data of a reusable item relevant to environmental contribution of the reusable item, the part data including at least the number of times of reuse of the reusable item; a selection unit that selects a candidate of the reusable item that is a part candidate of replacement when a user replaces a part; a calculation unit that calculates an environmental contribution degree of the candidate of the reusable item selected by the selection unit, based on the part data of the reusable item acquired by the data acquisition unit; and a presentation unit that presents, to the user, the environmental contribution degree of the candidate of the reusable item calculated by the calculation unit together with the candidate of the reusable item selected by the selection unit. In the information processing system according to the first aspect, the part data may further include a use time of the reusable item and the number of times of repair of the reusable item. The calculation unit may calculate the environmental contribution degree based on the number of times of reuse, the use time, and the number of times of repair. In the information processing system according to the first aspect, the part data may further include a resource use amount of the reusable item. The calculation unit may calculate the environmental contribution degree based on the number of times of reuse, the use time, the number of times of repair, and the resource use amount. The information processing system according to the first aspect may further include an incentive provision unit that provides an incentive to a terminal that has selected the candidate of the reusable item, based on the environmental contribution degree corresponding to the candidate of the reusable item selected by the selection unit. An information processing method according to a second aspect of the present disclosure includes: acquiring part data of a reusable item relevant to environmental contribution of the reusable item, the part data including at least the number of times of reuse of the reusable item; selecting a candidate of the reusable item that is a part candidate of replacement when a user replaces a part; calculating an environmental contribution degree of the selected candidate of the reusable item based on the acquired part data of the reusable item; and presenting, to the user, the calculated environmental contribution degree of the candidate of the reusable item together with the selected candidate of the reusable item.

An object of the present disclosure is to provide an information processing system and an information processing method capable of promoting cascade use by a user and improving environmental awareness of the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic system configuration of an information processing system according to the present embodiment;

FIG. 2 is a block diagram illustrating a schematic system configuration of a server according to the present embodiment;

FIG. 3 is a flowchart illustrating a flow of the information processing method according to the present embodiment; and

FIG. 4 is a block diagram illustrating a schematic system configuration of a server according to the present embodiment.

### DETAILED DESCRIPTION OF EMBODIMENTS

### Embodiment 1

Hereinafter, embodiments of the present disclosure will be described with reference to the drawings.

In recent years, reuse of products has been demanded from the viewpoint of carbon neutral, sustainability, resource protection, and the like, and a system for promoting the reuse has been demanded.

On the other hand, in the information processing system according to the present embodiment, the degree of environmental contribution is calculated in consideration of the use state of the reused product, the number of repairs, the number of times of reuse, and the like, and the calculated degree of environmental contribution is used to promote the cascade use of the user, thereby improving the environmental consciousness of the user.

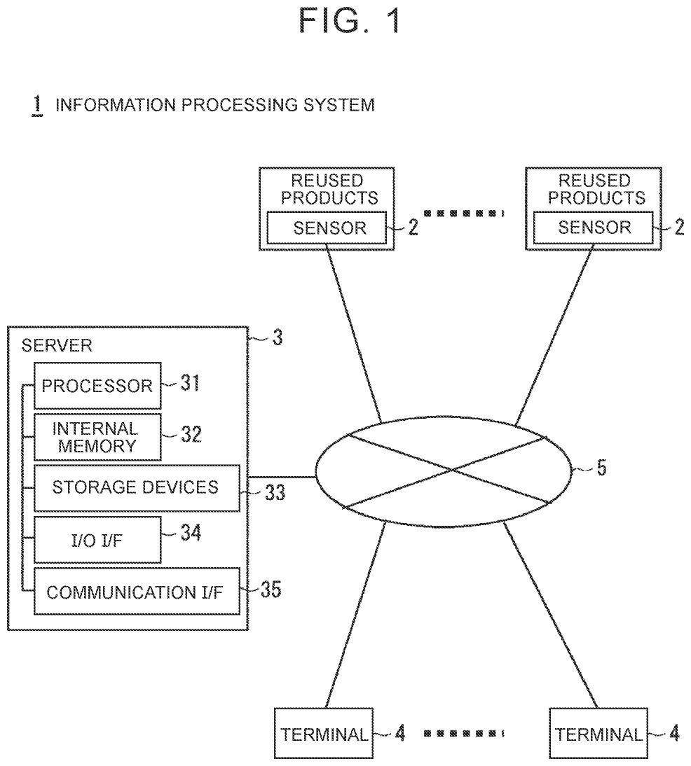

FIG. 1 is a block diagram illustrating a schematic system configuration of an information processing system according to an embodiment. The information processing system 1 according to the present embodiment includes a plurality of sensors 2 for detecting information of each reusable item, a server 3 for performing various kinds of information processing, and a plurality of terminals 4. The number of sensors 2 and the number of terminals 4 may be singular or arbitrary.

The sensor 2, the server 3, and the terminal 4 may transmit and receive information to and from each other via a communication network 5 such as the Internet, for example. Each of the sensor 2, the server 3, and the terminal 4 may communicate with the communication network 5 by performing wireless communication such as wireless Local Area Network (LAN) or Wireless Fidelity (Wifi).

The sensor 2 detects, for example, component data related to the environmental contribution of the reusable product. The reusable product is a component to be reused by a user, and includes, for example, a motor, a power control unit, a battery (a secondary battery, a fuel cell, a capacitor, and the like), a converter, an inverter, an electronic component, a cooling pump, an internal combustion engine, and the like incorporated in a vehicle such as a battery electric vehicle, hybrid electric vehicle.

The sensor 2 is attached to, for example, a reusable article, and detects component data of the reusable article. Sensor 2 includes, for example, a revolving sensor, a temperature sensor, a volt sensor, Global Positioning System (GPS) sensors incorporated in advance into the product. Note that the sensor 2 may be specially attached to the product when the product is reused. The sensor 2 may be a sensor incorporated in advance in a component or the like in which a reusable product is incorporated.

The sensor 2 detects, for example, the use time of the reusable product as the component data. Here, the use time of the reusable article refers to, for example, a time during which the reusable article (such as a motor) is in an ON state or an operating state. Further, the use time may be the number of times of use or the number of cycles.

The sensor 2 may include an input device into which specification information, the number of times of reuse, the number of repairs, and the like of the reused product are input as component data when the product is reused (such as when the reused product is sold). The specification information of the reusable product includes, for example, specification values such as a rated value of the motor, and information such as a usage amount (hereinafter, resource usage amount) of resources such as copper and iron used in the motor.

The identification information including the component ID information for recognizing the type and the like of the respective reused products may be set or inputted in advance in the sensor 2. The sensor 2 transmits the detected or input component data and identification information of the reused product to the server 3 at a predetermined cycle, for example.

The server 3 has a hardware configuration of an ordinary computer including, for example, a processor 3a such as Central Processing Unit (CPU) or Graphics Processing Unit (GPU), an internal memory 3b such as Random Access Memory (RAM) or Read Only Memory (ROM), an input/output I/F 3d for connecting a peripheral device such as a display and a storage device 3c such as Hard Disk Drive (HDD) or Solid State Drive (SSD), and a communication I/F 3e for communicating with an external device.

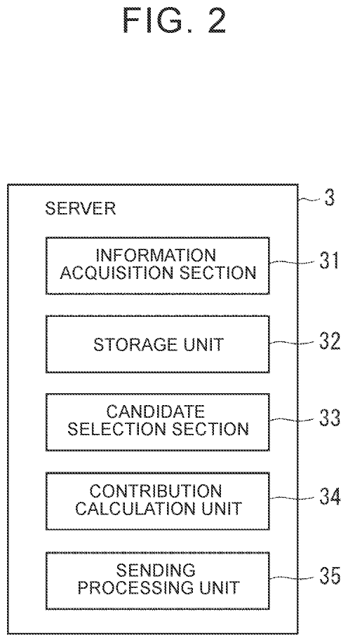

FIG. 2 is a block diagram illustrating a schematic system configuration of a server according to the present embodiment. The server 3 includes a data acquisition unit 31 that acquires component data of a reusable product, a storage unit 32 that stores component data of the reusable product, a candidate selection unit 33 that selects a candidate of the reusable product, a contribution degree calculation unit 34 that calculates an environmental contribution degree of the reusable product, and a transmission processing unit 35 that transmits the environmental contribution degree of the candidate of the reusable product together with the candidates of the plurality of reusable products to the terminal 4 of the user.

The data acquisition unit 31 and the sensor 2 described above is a specific example of the data acquisition means. The data acquisition unit 31 acquires component data and identification information transmitted from the sensor 2 of the reusable product.

The storage unit 32 includes, for example, the above-described storage device. The storage unit 32 stores the component data of the reused product acquired by the data acquisition unit 31 in association with the identification information of the reused product. The storage unit 32 stores, for example, component data such as the use time, the number of times of reuse, and the number of times of repair of the reused product in association with the identification information of the reused product.

When the user replaces a component, the terminal 4 transmits information on a candidate of a reusable product (hereinafter referred to as a reusable product candidate), which is a component candidate for the replacement, to the candidate selection unit 33 of the server 3 as request information of the reusable product.

The terminal 4 includes a mobile terminal such as a smartphone, an information terminal such as a tablet terminal, or a personal computer. The terminal 4 includes, for example, a display unit such as a liquid crystal display or an organic EL display, and an input unit including a touch panel and input keys for inputting data.

The candidate selection unit 33 is a specific example of a selection unit. The candidate selection unit 33 selects a reusable item candidate based on the request information of the reusable item transmitted from the terminal 4.

The candidate selection unit 33 selects a plurality of reusable item candidates from among the plurality of reusable item candidates stored in the storage unit 32 based on the part data and the identification information of the reusable item stored in the storage unit 32.

The candidate selection unit 33 selects, for example, a plurality of reusable product candidates that are the same type of parts as the replacement parts required by the request information of the terminal 4 and that are lower than the specification value (motor rated value or the like) of the replacement parts on the basis of the specification information of the reusable product. The candidate selection unit 33 outputs the plurality of reusable item candidates selected as described above to the contribution degree calculation unit 34.

The contribution degree calculation unit 34 is a specific example of a calculation unit. The contribution degree calculation unit 34 calculates the environmental contribution degree of the reusable item candidate selected by the candidate selection unit 33 based on the part data of the reusable item acquired by the data acquisition unit 31 and stored in the storage unit 32. Here, the degree of environmental contribution is an index value indicating a degree of contribution to environmental conservation, and is an index value indicating, for example, how much CO2 emission could be reduced by eliminating the need for new manufacturing, assembly, transportation, etc. due to the use of reused products.

The part data preferably includes at least the number of times of reuse of the reusable item candidate, the use time of the reusable item candidate, and the number of times of repair of the reusable item candidate. This is because these parameters greatly affect the environmental contribution described above.

The contribution degree calculation unit 34 calculates the environmental contribution degree of the reused item candidate on the basis of the number of times of reuse of the reused item candidate acquired by the data acquisition unit 31, the use time of the reused item candidate, and the number of times of repair of the reused item candidate. The degree of environmental contribution is calculated so as to be larger as the reused product is used in consideration of the number of times of reuse, the use time, and the number of times of repair of the reused product. Accordingly, the degree of environmental contribution can be calculated in consideration of the number of times of reuse, the use time, and the number of times of repair of the reusable product, and the user's awareness of reuse can be improved by using the degree of environmental contribution.

For example, the contribution degree calculation unit 34 calculates the environmental contribution degree of the reused product candidate by using the following expression.

Environmental Contribution of Reused Candidates={(number of reuse of reusable item candidates)×A1+(number of use of reusable item candidates)×A2}×(number of repairs of reusable item candidates)×A3

A1, A2, A3 is a weighting factor of the number of times of reuse, the number of times of use, and the number of times of repair, respectively. Each coefficient is set in advance, but can be changed as appropriate. For example, each of the above coefficients may be set so that the weighting for the parameter affecting the degree of environmental contribution is larger.

Further, the contribution degree calculation unit 34 may calculate the environmental contribution degree of the reused product candidate by using the following expression.

Environmental Contribution of Reused Candidates=(number of reuse candidates)×A1+(time of reuse candidates)×A2+(number of repairs for reuse candidates)×A3

The contribution degree calculation unit 34 may calculate the environmental contribution degree of the reused item candidate by using the resource usage amount of the reused item candidate (for example, the usage amount (weight or the like) of copper or the like) in addition to the above-described number of times of reuse, the use time, and the number of times of repair.

For example, as the resource consumption of reusable products increases, a large amount of energy is required for manufacturing, assembling, transporting, and the like. As described above, the degree of environmental contribution can be calculated in consideration of the resource usage amount of the reusable product, and the user's awareness of reuse can be improved by using the degree of environmental contribution.

The contribution degree calculation unit 34 may calculate the environmental contribution degree of the reusable item candidate by using the following expression.

Environmental Contribution of Reused Candidates=(number of reuse candidates)×A1+(time of reuse candidates)×A2+(number of repairs of reuse candidates)×A3+(resource usage of reuse candidates)×A4

Note that A4 is a weighting factor of the resource usage, which is set in advance, but can be changed as appropriate.

The contribution degree calculation unit 34 may calculate the environmental contribution degree of the reused product candidate by using the specification value (for example, the rated value of the motor) of the reused product candidate in addition to the number of reuse, the use time, and the number of repairs described above.

For example, as the rated value of the motor, which is a reused product, decreases, the power consumption consumed by the motor also decreases, and energy saving is achieved, so that the degree of environmental contribution by reuse increases. As described above, the degree of environmental contribution can be calculated in consideration of the specification value of the reusable product, and the user's awareness of reuse can be improved by using the degree of environmental contribution.

Environmental Contribution of Reused Candidates=(number of reuse candidates)×A1+(time of reuse candidates)×A2+(number of repairs for reuse candidates)×A3+(reduction in specification due to reuse)×A5

Note that A5 is a weighting factor of the resource usage, which is set in advance, but can be changed as appropriate.

Note that the method of calculating the degree of environmental contribution is not limited to the above-described example. If the degree of environmental contribution is calculated so that the use of the reusable product increases more greatly, the degree of environmental contribution may be calculated using an arbitrary calculation method. The contribution degree calculation unit 34 outputs the calculated environmental contribution degree of the reusable item candidate to the transmission processing unit 35.

The transmission processing unit 35 is a specific example of a presentation unit. The transmission processing unit 35 transmits the environmental contribution degree of the reusable item candidate calculated by the contribution degree calculation unit 34 together with the reusable item candidate selected by the candidate selection unit 33 to the terminal 4 of the user. The transmission processing unit 35 transmits a corresponding plurality of sets of reusable item candidates and the environmental contribution degree to the terminal 4 of the user in accordance with the request information of the reusable item transmitted from the terminal 4.

The terminal 4 displays the plurality of sets of reusable item candidates and the environmental contribution degree transmitted from the transmission processing unit 35 of the server 3 on the display unit. The display unit displays, for example, the reusable item candidates and the environmental contribution degree in association with each other.

The display unit may be constituted by a touch panel or the like. For example, the user can select a reusable item candidate by touching a desired reusable item candidate area on the display unit. At this time, the user selects the reused item candidate by being aware of the degree of environmental contribution corresponding to the reused item candidate. Accordingly, it is possible to stimulate the user's awareness of reuse, to promote the user's cascade use, and to improve the environmental awareness.

The terminal 4 transmits the identification information of the reusable item candidate selected by the user to the server 3. For example, the retailer or the like acquires the reused product based on the identification information of the reused product transmitted to the server 3, and provides the reused product to the user.

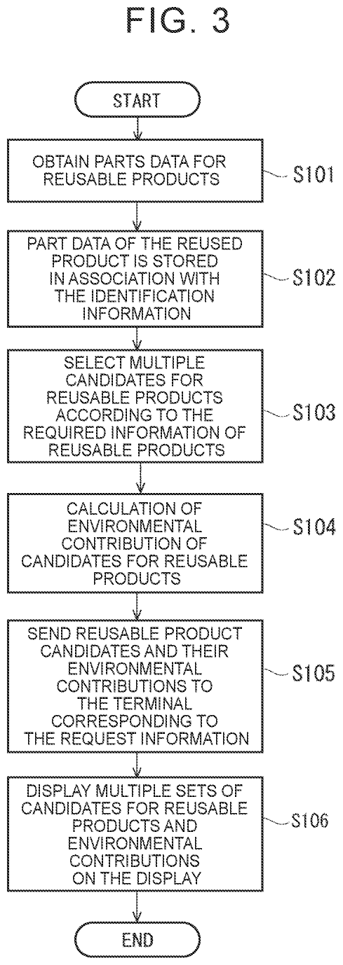

Next, an information processing method according to the present embodiment will be described. FIG. 3 is a flowchart illustrating a flow of the information processing method according to the present embodiment.

The data acquisition unit 31 of the server 3 acquires the component data of the reusable product (S101). The storage unit 32 stores the component data of the reusable product acquired by the data acquisition unit 31 in association with the identification information of the reusable product (S102).

The candidate selection unit 33 selects a plurality of reusable item candidates from among the plurality of reusable item candidates stored in the storage unit 32 based on the part data and the identification information of the reusable item stored in the storage unit 32 in accordance with the required information of the reusable item transmitted from the terminal 4 (S103).

The contribution degree calculation unit 34 calculates the environmental contribution degree of the reusable item candidate selected by the candidate selection unit 33 based on the part data of the reusable item acquired by the data acquisition unit 31 and stored in the storage unit 32 (S104).

The transmission processing unit 35 transmits the environmental contribution degree of the reusable item candidate calculated by the contribution degree calculation unit 34 together with the reusable item candidate selected by the candidate selection unit 33 to the terminal 4 of the user corresponding to the requested information (S105).

The terminal 4 displays a plurality of sets of reusable product candidates and environmental contributions transmitted from the transmission processing unit 35 of the server 3 on the display unit (S106).

As described above, the information processing system according to the present embodiment includes: a data acquisition unit 31 that acquires component data of the reusable product related to the environmental contribution of the reusable product including at least the number of times of reuse of the reusable product; a candidate selection unit 33 that selects a candidate of the reusable product that is the replacement component candidate when the user replaces the component; a contribution degree calculation unit 34 that calculates the environmental contribution degree of the candidate of the reusable product selected by the candidate selection unit 33 based on the component data of the reusable product acquired by the data acquisition unit 31; and a transmission processing unit 35 that transmits the environmental contribution degree of the reusable product candidate calculated by the contribution degree calculation unit 34 to the terminal 4 of the user together with the candidate of the reusable product selected by the candidate selection unit 33. As a result, the user selects the reusable item candidate based on the degree of environmental contribution corresponding to the reusable item candidate, and stimulates the user's reuse consciousness, thereby promoting the cascade use of the user and improving the environmental consciousness.

### Embodiment 2

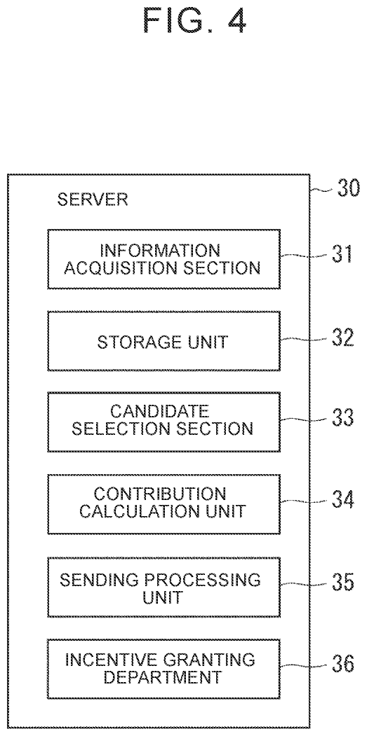

FIG. 4 is a block diagram illustrating a schematic system configuration of a server according to the present embodiment. The server 30 according to the present embodiment further includes an incentive providing unit 36 that provides an incentive to the terminal 4 according to the degree of environmental contribution.

The incentive providing unit 36 is a specific example of an incentive provision unit. The incentive providing unit 36 provides an incentive to the terminal 4 that has selected the reusable item candidate, based on the environmental contribution corresponding to the reusable item candidate selected by the candidate selection unit 33.

The incentive is, for example, a point, a discount ticket (coupon), or the like that can be used at a shopping site, a service site, or the like on the Internet. For example, the incentive providing unit 36 may give more points or discount tickets to the terminal 4 that has selected the reusable item candidate as the environmental contribution of the reusable item candidate increases.

For example, the contribution degree calculation unit 34 calculates the environmental contribution degree of the reused item candidate based on the part data of the reused item candidate acquired by the data acquisition unit 31. The incentive providing unit 36 sets an incentive for the reusable item candidate based on the degree of environmental contribution corresponding to the reusable item candidate selected by the candidate selection unit 33.

The transmission processing unit 35 transmits the information of the incentive set by the incentive providing unit 36 to the terminal 4 of the user, together with the reusable item candidate selected by the candidate selection unit 33 and the environmental contribution of the reusable item candidate calculated by the contribution degree calculation unit 34.

The terminal 4 displays a plurality of sets of reusable item candidates, an environmental contribution degree, and an incentive transmitted from the transmission processing unit 35 of the server 30 on the display unit. At this time, since more incentives are given as the degree of environmental contribution increases, the user selects a reusable item candidate that has a greater degree of incentive and a greater degree of environmental contribution. In this way, it is possible to further stimulate the user's awareness of reuse by using the incentive, thereby promoting the user's cascade use and improving the environmental awareness.

While certain embodiments have been described, these embodiments have been presented by way of example only, and are not intended to limit the scope of the disclosure. These novel embodiments can be implemented in various other forms, and various omissions, replacements, and modifications can be made without departing from the gist of the disclosure. These embodiments and variations thereof fall within the scope and spirit of the disclosure, and fall within the scope of the disclosure described in the claims and equivalents thereof.

For example, the present disclosure can be realized by causing a processor to execute a computer program in the processing illustrated in FIG. 3.

The program can be stored using various types of non-transitory computer readable medium and supplied to a computer. Non-transitory computer-readable media include various types of tangible storage media. Exemplary non-transitory computer-readable media include magnetic recording media (e.g., flexible disks, magnetic tapes, hard disk drives), magneto-optical recording media (e.g., magneto-optical disks), CD-ROM (Read Only Memory), CD-R, CD-R/W, solid-state memories (e.g., masking ROM, Programmable ROM (PROM), Erasable PROM (EPROM), flash ROM, random access memory (RAM).

The program may be supplied to the computer by various types of transitory computer readable medium. Examples of transitory computer-readable media include electrical signals, optical signals, and electromagnetic waves. The transitory computer readable medium can supply the program to the computer via a wired communication path such as an electric wire and an optical fiber, or a wireless communication path.

Each unit constituting the servers 3 according to the above-described embodiments can be realized not only by a program but also by dedicated hardware such as Application Specific Integrated Circuit (ASIC) or Field-Programmable Gate Array (FPGA).

What is claimed is:

1. An information processing system comprising:
a data acquisition unit that acquires part data of a reusable item relevant to environmental contribution of the reusable item, the part data including at least the number of times of reuse of the reusable item;
a selection unit that selects a candidate of the reusable item that is a part candidate of replacement when a user replaces a part;
a calculation unit that calculates an environmental contribution degree of the candidate of the reusable item selected by the selection unit, based on the part data of the reusable item acquired by the data acquisition unit; and
a presentation unit that presents, to the user, the environmental contribution degree of the candidate of the reusable item calculated by the calculation unit together with the candidate of the reusable item selected by the selection unit.

2. The information processing system according to claim 1, wherein:
the part data further includes a use time of the reusable item and the number of times of repair of the reusable item; and
the calculation unit calculates the environmental contribution degree based on the number of times of reuse, the use time, and the number of times of repair.

3. The information processing system according to claim 2, wherein:
the part data further includes a resource use amount of the reusable item; and
the calculation unit calculates the environmental contribution degree based on the number of times of reuse, the use time, the number of times of repair, and the resource use amount.

4. The information processing system according to claim 1, further comprising an incentive provision unit that provides an incentive to a terminal that has selected the candidate of the reusable item, based on the environmental contribution degree corresponding to the candidate of the reusable item selected by the selection unit.

5. An information processing method comprising:
acquiring part data of a reusable item relevant to environmental contribution of the reusable item, the part data including at least the number of times of reuse of the reusable item;
selecting a candidate of the reusable item that is a part candidate of replacement when a user replaces a part;
calculating an environmental contribution degree of the selected candidate of the reusable item based on the acquired part data of the reusable item; and
presenting, to the user, the calculated environmental contribution degree of the candidate of the reusable item together with the selected candidate of the reusable item.
